(19) United States
(12) Patent Application Publication
(10) Pub. No.: US 2004/0161989 A1
(43) Pub. Date: Aug. 19, 2004

(54) Anti-projectile barrier fabric and method

(75) Inventors: Michael R. Dennis, Scappoose, OR (US); Russell A. Monk, Salem, OR (US)

Correspondence Address: Robert D. Varitz, ROBERT D. VARITZ, P.C., 2007 S.E. Grant Street, Portland, OR, 97214, US

(73) Assignee: MJD Innovations, L.L.C.

(21) Appl. No.: 10/368,975

(22) Filed: Feb. 19, 2003

(51) Int. Cl. B32B 5/26

(52) U.S. Cl. 442/135; 442/221; 442/223; 442/224; 442/239; 442/255; 428/911; 2/2.5

(57) ABSTRACT

An anti-projectile barrier fabric which takes the form of a plural-layer assembly of two outer cloth-like layers, each preferably formed of a Nylon material, a pair of foam-like layers, each preferably formed of a cross-linked polyethylene material and disposed inwardly of, and bonded to, the two cloth-like layers, and a central, inner strand layer, preferably formed of elongate, cross-deployed strands of a non-stretchable material, such as Kevlar®, bonded to the confronting inner surfaces of the two foam-like layers.

This invention relates to a barrier method and structure for furnishing defense against high-speed, hollow-point bullets. In particular, it relates to such a method and structure that feature a unique, light weight fabric that can be assembled easily into many forms, such as comfortable wearable articles of clothing, as well as other kinds of structures. A preferred embodiment of the invention, for representative illustration purposes, is disclosed herein in the configuration of a personnel vest.

In the past, anti-projectile, and in particular, anti-bullet, defense methods and structures have typically focused attention on relatively stiff, not very pliable, and often bulky and relatively heavy, barrier materials. And, while recent developments in such materials have made modest improvements regarding these characteristics, there is still much conventional attention being directed toward retaining stiffness and rigidity-qualities which have enough detraction that resulting barrier devices are often employed (by user choice) only to cover selected, “especially vital” body areas (in the case of body armor)—leaving many body expanses quite fully exposed and vulnerable. Additionally, currently available and wearable anti-bullet garments may only be one-time useable, and in that context, are usually only somewhat effective against a conventional, non-hollow-point bullet. More dangerous hollow-point bullets, however, are usually successful challengers to conventional, wearable defense garmentry, and have not heretofore been very successfully neutralized, or tamed.

The present invention specifically addresses this issue in a quite surprising and successful way. Contrary to conventional wisdom which leans heavily toward relying upon hardened, stiffened, and often heavy barrier structure, the present invention proposes a method and structure which feature a special plural-layer, quite flexible, pliable and light-weight fabric material which is capable not only definitively of stopping many non-hollow-point bullets, such as nine-millimeter bullets, but also of dealing extremely effectively, in a mitigating way, with many hollow-point bullets. The fabric of this invention tames such hollow-point bullets by first collapsing the hollow-point structures of these bullets, and in the process, significantly slowing, and even sometimes fully stopping, them.

The various features and performance capabilities (methodologies) of the present invention will become more fully apparent as the description which now follows is read in conjunction with the accompanying drawings.

### DESCRIPTION OF THE DRAWINGS

FIG. 1 is an isometric view of an anti-projectile, plural-layer personnel vest made from fabric constructed in accordance with a preferred and best-mode embodiment of the present invention.

FIG. 2 is an enlarged, fragmentary plan view of an impact-expanse portion of the fabric which forms the vest shown in FIG. 1. Portions of four layers in this fabric have been broken away to reveal details of construction.

FIG. 3 is a further enlarged, fragmentary, cross-sectional view taken generally along the line 3-3 in FIG. 2.

FIG. 4, which is drawn on a somewhat smaller scale than employed in FIG. 3, presents a simplified, fragmentary and partially broken-away side elevation of a conventional hollow-point bullet round. In solid lines, this bullet round is illustrated with its bullet in a pre-impact condition. In dash-dot lines, it is shown, or more specifically its bullet projectile is shown, in a post-impact, deformed and radially outwardly splayed condition.

FIG. 5, which is prepared on about the same drawing scale as that which is used in FIG. 4, shows the bullet (projectile) of FIG. 4 in one of many possible splay-defeated conditions after it has struck the fabric of the present invention. As illustrated here, this bullet has been subjected to substantially full, radial-inward collapse of its once initially open, “hollow-point” front end—its impact end.

### DETAILED DESCRIPTION OF THE INVENTION

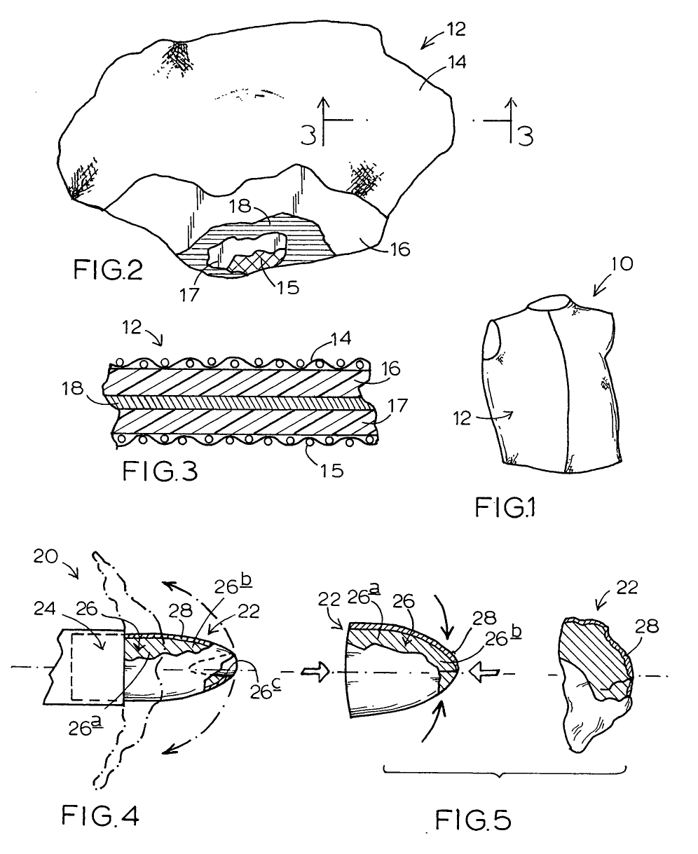

Turning now to the drawings, shown generally at 10 in FIG. 1 is an anti-projectile, personnel defense vest made of a barrier fabric 12 which is constructed, and which performs, in accordance with a preferred and best-mode embodiment of the present invention. FIGS. 2 and 3 specifically illustrate fabric 12. Vest 10, a sleeveless garment, is fully made of fabric 12, which fabric is lightweight and quite flexible and pliable, and which fabric also, pursuant to its special inventive features, forms throughout the entirety of vest 10 what is referred to herein as a bullet-protective impact expanse. Vest 10 herein weighs about 5-lbs. Other kinds of garments than a vest may, of course, be made of fabric 12, and indeed other bullet-protecting structures, such as headgear, pants, jackets, shrouds, blankets, tents, and so on, may readily be formed of this fabric to suit different selected applications. Fabric 12 may also be employed in settings where multiple layers of the integrated fabric material per se is stacked” to provide additional protection.

As can be seen in FIGS. 2 and 3, fabric 12 possesses a layered structure (five herein), including two nylon cloth layers, or cloth-like, outer layer 14, 15, two cushioning foam, or foam-like, intermediate layers 16, 17, and a central non-stretchable strand (such as Keviar®) inner layer 18. In vest 10, substantially all areas, or expanses, in each of layers 14, 15, 16, 17, 18 constitute impact expanses herein, also referred to as defined impact expanses. While different layer numbers, or counts, may be employed in modified forms of the invention, the five-layer collection of materials just described as making up fabric 12 as illustrated herein, is very suitable to most applications. One modification, for example, could include a plurality of central strand layers. The five layers shown herein have a combined thickness preferably in the range of about ⅝-inches to about ¾-inches, with each of foam layers 16, 17 having a thickness of about ¼-inches, central layer 18 having a thickness of about 3/32-inches, and each of layers 14, 15 having a thickness of about 1/64-inches.

Cloth layers 14, 15 preferably are plastic layers made of 100-Denier Nylon cloth.

Foam-like layers 16, 17 are preferably formed of 2-lb cross-linked polyethylene.

Strand layer 18 is preferably constructed of elongate, cross-deployed (woven) strands of the non-stretchable material known as #706 Kevlar®. Other fabric structures could, of course, be used.

Layers 14, 15 are preferably joined to layers 16, 17, respectively by about a 3-mil thick layer of a distributed heat-settable adhesive, such as Permagrip #105 made by Sovereign Chemical Company in Akron, Ohio.

Layers 16, 17 are preferably bonded to the opposite faces of strand layer 18 by the same adhesive just identified above.

Plural-layer, composite fabric material 12, as above described and illustrated, has a unit-area weight of about 2½-pounds-per-square-yard, and can easily be shaped and formed into many different kinds of bullet-protecting structures, such as those listed non-exhaustively above, including, naturally, vest 10. This fabric material can be patterned and cut appropriately, and stitched, or otherwise assembled, into substantially any finally desired form. In certain applications, it can also be stacked to create a defensive structure of greater thickness.

The observed capability of fabric 12 to provide disabling defense against projectiles, such as against hollow-point bullets, will now be generally described. The exact mechanism of this defense is not currently precisely understood, but the reality of it is quite evident. This reality springs, it is believed, from the special and particular selected arrangement of the identified plural, differently functioning layers which produces a remarkable dissipation of projectile energy, including hollow-point bullet-tip collapse.

FIGS. 4 and 5 help to tell the defense story. Shown at 20 in these figures is a representative, hollow-point bullet round which includes a bullet, or projectile, 22 and a casing, or shell, 24. Bullet 22 has a central body 26 which resides in a copper jacket 28. Body 26 has a generally solid, cylindrical rear portion 26a which joins with a somewhat “rounded-conical” front portion 26b that is formed as a skirt which circumsurrounds and defines a central hollow region 26c. A central core component 30 joined to body 26 at the inside central base of hollow region 26c is also provided in bullet 22. This inside central component is intended to play a role in promoting outward radial splaying of skirt 26b when bullet 22 strikes a target.

In solid lines in FIG. 4, bullet 22 is shown in an “original”, un-deformed (un-splayed) condition. In dash-dot lines in this figure, and in a somewhat idealized and uniform manner, skirt 26b is shown radially outwardly splayed, as is intended after the occurrence of a target strike. Such splaying, which is specifically different (typically) for each spent bullet after an impact, is, of course, not usually uniform, and in addition, is frequently quite irregular and jagged.

FIG. 5 shows, in a certain idealized and uniform manner, how fabric 12 deals with an impacting bullet, such as bullet 22, which has been en route from a firing source to an intended target. What is clearly evident here is that splaying of the bullet's hollow point has been defeated, and, the hollow point has been radially inwardly collapsed. It should be appreciated that the ability of the fabric of this invention to deal with hollow-point bullets is also observed to deal effectively with other types of bullets.

As has been stated earlier, the impressive and effective anti-projectile performance of fabric 12 is not exactly understood, but certain cooperative qualities of its integrated plural layers may be important contributors. The central strand layer of Kevlar®, or a like strand material, stridently resists penetration and breakage. The springy foam layers which are bonded to the opposite faces of the stand layer compress, tense and rebound with the occurrence of a projectile impact, and dissipate much kinetic energy as heat. The outer cloth layers collaborate, it seems, with the central strand layer to distribute load quickly radially from the point of an impact.

The invention thus offers appreciable protection and defense to projectiles, such as hollow-point bullets. Variation in dimensions, specific materials and layer count, among other things, are certainly possible well within the contributed scope of this invention, and will be apparent to those of general skill in the art.

We claim:

1. A plural-layer, anti-projectile barrier fabric for defeating the designed splaying capability of a hollow-point bullet comprising
a pair of outer, plastic cloth layers each formed of a material such as Nylon, and each having inner and outer surfaces,
a pair of spaced, generally locally parallel-planar, springy foam layers each having inner and outer surfaces, with each foam layer's outer surface formed of a material such as cross-linked polyethylene, and being surface bonded to a different one of said cloth layers' inner surfaces, and
a central strand layer having a pair of outer surfaces formed of cross-deployed, elongate, non-stretchable strands made of a material such as Kevlar®, and having a pair of outer surfaces each of which is surface bonded to a different one of said foam layers' said inner surfaces.

2. A plural-layer, anti-projectile barrier fabric for collapsing, radially inwardly, the open, hollow-point impact end of an elongate bullet comprising
a cloth-like layer formed of a nylon-type material and having a defined impact expanse defined by opposite sides,
a foam-like layer having a defined impact expanse with opposite sides, one of which is bonded to and distributed spanningly over one side of the impact expanse in said cloth-like layer,
a strand layer formed of cross-deployed, elongate strands characterized by Kevlar®-like characteristics, and having an impact expanse with opposite sides, one of which is bonded to the opposite side of said foam-like layer relative to said cloth layer, and which spans said impact expanse in said foam-like layer,
a second foam-like layer having a defined impact expanse with opposite sides, one of which is bonded to the opposite side of said stand layer relative to said first-mentioned foam-like layer, and
a second cloth-like layer having a defined impact expanse with opposite sides, one of which is bonded to the opposite side of said second foam-like layer relative to said strand layer.

3. A method for collapsing, radially inwardly, the open, hollow-point, impact end of an elongate bullet which is en route from a firing source of the projectile to an intended target comprising
engaging such a projectile first by a layered barrier fabric which takes the form of,
a cloth-like layer formed of a nylon-type material and having a defined impact expanse defined by opposite sides,
a foam-like layer having a defined impact expanse with opposite sides, one of which is bonded to and distributed spanningly over one side of the impact expanse in said cloth-like layer,
a strand layer formed of cross-deployed, elongate strands characterized by Kevlar®-like characteristics, and having an impact expanse with opposite sides, one of which is bonded to the opposite side of said foam-like layer relative to said cloth layer, and which spans said impact expanse in said foam-like layer,
a second foam-like layer having a defined impact expanse with opposite sides, one of which is bonded to the opposite side of said stand layer relative to said first-mentioned foam-like layer, and
a second cloth-like layer having a defined impact expanse with opposite sides, one of which is bonded to the opposite side of said second foam-like layer relative to said strand layer.
